(19) United States
(12) Patent Application Publication
(10) Pub. No.: US 2022/0344769 A1
(43) Pub. Date: Oct. 27, 2022

(54) VENT PLUG FOR LEAD-ACID BATTERY AND LEAD-ACID BATTERY

(71) Applicant: GS Yuasa International Ltd., Kyoto-shi, Kyoto (JP)

(72) Inventors: Tatsuya MORII, Shizuoka (JP); Shinsuke OKI, Shizuoka (JP); Yu KOJIMA, Shizuoka (JP)

(21) Appl. No.: 17/760,935

(22) PCT Filed: Sep. 7, 2020
(86) PCT No.: PCT/JP2020/033730

§ 371 Date: Mar. 16, 2022

(30) Foreign Application Priority Data
Sep. 20, 2019 (JP) 2019-171066

(51) Int. Cl. H01M 50/308

(52) U.S. Cl. CPC H01M 50/308; H01M 10/06

(57) ABSTRACT

A vent plug (18) includes a head portion (35), a cylindrical portion (36) extending from the head portion (35), and a filter (34) provided inside the cylindrical portion (36). The cylindrical portion (36) has a through hole (43) that allows an inside and an outside of the cylindrical portion (36) to communicate with each other. The through hole (43) has an opening portion on an inner peripheral surface of the cylindrical portion (36). The filter (34) is provided so as to close the opening portion of the through hole (43).

### TECHNICAL FIELD

The present invention relates to a vent plug for a lead-acid battery and a lead-acid battery.

### BACKGROUND ART

Lead-acid batteries are in use for various applications, including automotive and industrial applications. A lead-acid battery includes an element in which a positive electrode plate and a negative electrode plate are alternately stacked with a separator interposed therebetween. In the lead-acid battery, the element is immersed in an electrolyte solution held in a container, and an opening portion of the container is sealed by a lid body. Some of such lead-acid batteries include a lid provided with a vent plug for replenishing an electrolyte solution. The vent plug includes a cylindrical body whose lower end is opened and a head portion that seals an upper end of the cylindrical body. In some vent plugs, a through hole for connecting with an exhaust path communicating with a vent hole provided in the lid is formed. The through hole, the exhaust path, and the vent hole have a function of discharging oxygen gas and hydrogen gas generated in plates in the container during charging of the lead-acid battery to the outside of the lead-acid battery.

In a lead-acid battery, a phenomenon in which moisture in an electrolyte solution decreases (hereinafter, referred to as “liquid depletion”) may occur. The cause of the liquid depletion may be, for example, as follows. When the lead-acid battery is used under a high-temperature environment such as an engine room, for example, water vapor generated by evaporation of part of moisture in the electrolyte solution is released to the outside of a cell chamber through the vent hole of the vent plug, or the electrolyte solution becomes a mist and is released to the outside of the cell chamber through the vent hole of the vent plug. As a result, liquid depletion occurs in each cell chamber. When liquid depletion occurs, problems such as a decrease in battery capacity and corrosion of a current collector connected to the element may occur.

For example, Patent Document 1 discloses a lead-acid battery including vent plugs attached to liquid ports provided on an exterior of the lead-acid battery, and a sheet covering the exhaust ports of the vent plugs. As described above, by providing the sheet covering the vent holes of the vent plug, water vapor is not easily released from the inside of the battery, and liquid depletion of the electrolyte solution due to discharge of water vapor from the inside of the storage battery is suppressed.

### PRIOR ART DOCUMENT

### Patent Document

Patent Document 1: JP-A-2005-276741

### SUMMARY OF THE INVENTION

### Problems to Be Solved By the Invention

The inventors of the present application have focused on the fact that the liquid depletion in the lead-acid battery occurs when water vapor or mist is discharged to the outside through the vent plugs, and have arrived at the invention of the present application. That is, an object of the present invention is to provide a vent plug for a lead-acid battery and a lead-acid battery capable of suppressing liquid depletion.

### Means for Solving the Problems

In order to solve the above problems, a vent plug for a lead-acid battery according to the present invention is a vent plug for a lead-acid battery including a head portion, a cylindrical portion extending from the head portion, and a filter provided inside the cylindrical portion, in which the cylindrical portion has a through hole that allows an inside and an outside of the cylindrical portion to communicate with each other, in which the through hole has an opening portion on an inner peripheral surface of the cylindrical portion, and in which the filter is provided so as to close the opening portion of the through hole.

### BRIEF DESCRIPTION OF THE DRAWINGS

FIG. 1 is a perspective view showing a lead-acid battery 100 according to an embodiment of the present invention.

FIG. 2 is a perspective view of a vent plug 18 according to the embodiment of the present invention.

FIG. 3 is a front view of the vent plug 18 shown in FIG. 2.

FIG. 4 is a rear view of the vent plug 18 shown in FIG. 2.

FIG. 5 is a cross-sectional view taken along line A-A in FIG. 2, and is a view showing an internal structure of the vent plug 18.

FIG. 6 is a view showing a state in which the vent plug 18 shown in FIG. 2 is attached to a lid 15.

FIG. 7 is a view showing a vent plug 181 according to a modification example of the present invention, in which FIG. 7(a) is a plan view, and FIG. 7(b) is a rear view.

### MODE FOR CARRYING OUT THE INVENTION

Hereinafter, embodiments of the present invention will be described in detail with reference to the drawings.

### [Schematic Configuration of Lead-Acid Battery 100]

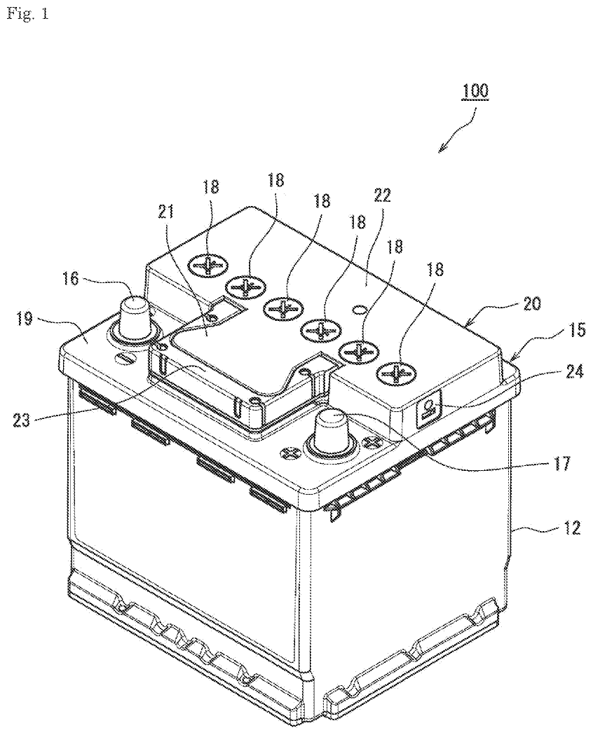

FIG. 1 is a perspective view showing a lead-acid battery 100 according to an embodiment of the present invention. As shown in FIG. 1, the lead-acid battery 100 includes a plurality of elements (not shown), an electrolyte solution (not shown), a container 12 which accommodates the elements and the electrolyte solution and has an opening on the upper side, and a lid 15 which seals the opening of the container 12.

The container 12 is a substantially rectangular parallelepiped case having the opening on the upper surface, and is formed of, for example, a synthetic resin. The container 12 has a partition wall. The inside of the container is partitioned into a plurality of cell chambers arranged in a predetermined direction by the partition wall. An element is disposed in each of the plurality of cell chambers.

The opening of the container 12 is sealed with the lid 15 having a shape corresponding to the opening. More specifically, the peripheral edge portion of the lower surface of the lid 15 and the peripheral edge portion of the opening portion of the container 12 are joined to each other by, for example, thermal welding. The lid 15 includes a base portion 19 and a plateau portion 20 projecting from the base portion 19. A negative electrode terminal 16 and a positive electrode terminal 17 are provided at the base portion of the lid 15.

The plateau portion 20 of the lid 15 includes a first projecting portion 21 projecting between the positive electrode terminal 17 and the negative electrode terminal 16, and a second projecting portion 22 extending in parallel with the arrangement direction of the positive electrode terminal 17 and the negative electrode terminal 16. The plateau portion 20 includes a handle 23 for a user of the lead-acid battery 100 to grip the lead-acid battery 100.

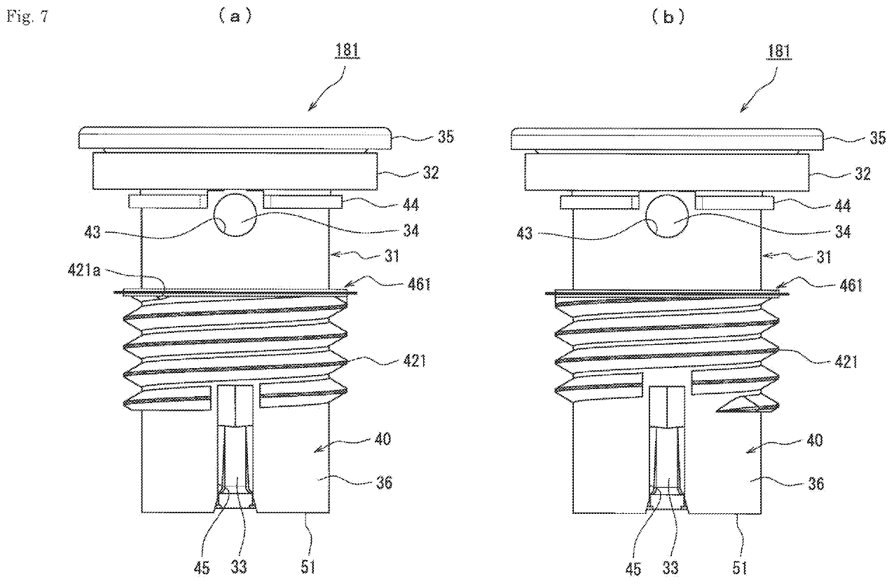

The second projecting portion 22 is provided with water filling ports 25 (see FIG. 7) at positions corresponding to the cell chambers, and the lid 15 is provided with vent plugs 18 for sealing the water filling ports 25. In the example shown in FIG. 1, the lid 15 includes six vent plugs. When water addition is performed on the lead-acid battery 100, the vent plugs 18 are removed and refilling liquid is added.

A vent hole 24 is provided in a side surface of the second projecting portion 22 of the lid 15. The vent hole 24 is connected to an exhaust path (not shown) provided in the lid 15, and discharges gas generated in each cell chamber to the outside. In addition, the vent hole 24 is provided at an end portion in the arrangement direction in which the vent plugs 18 are arranged when the lid 15 is viewed from the top. In other words, the vent hole 24 is provided such that the vent plugs 18 and the vent hole 24 are on a straight line.

### [Schematic Configuration of Vent Plug 18]

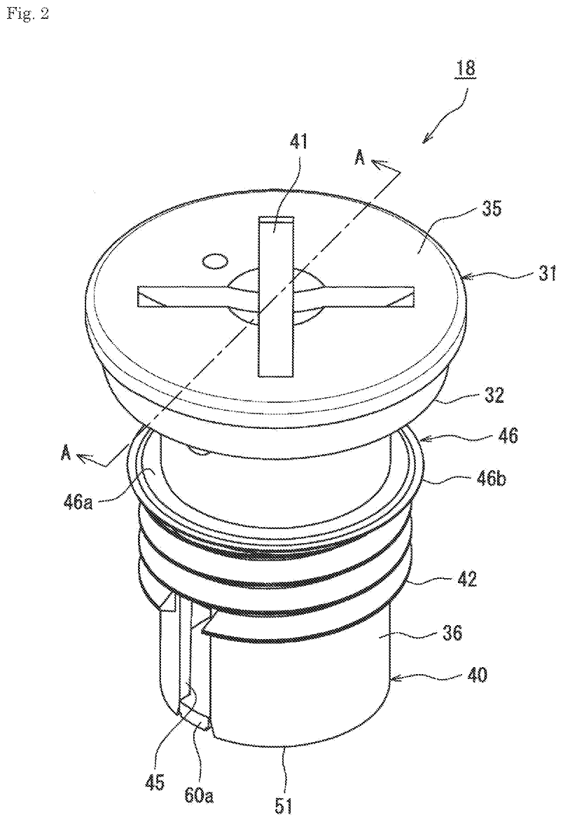

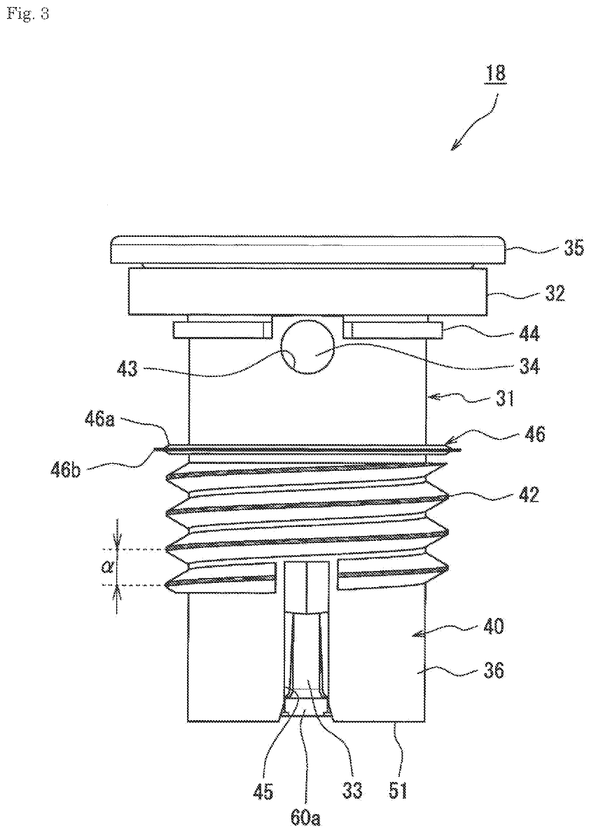

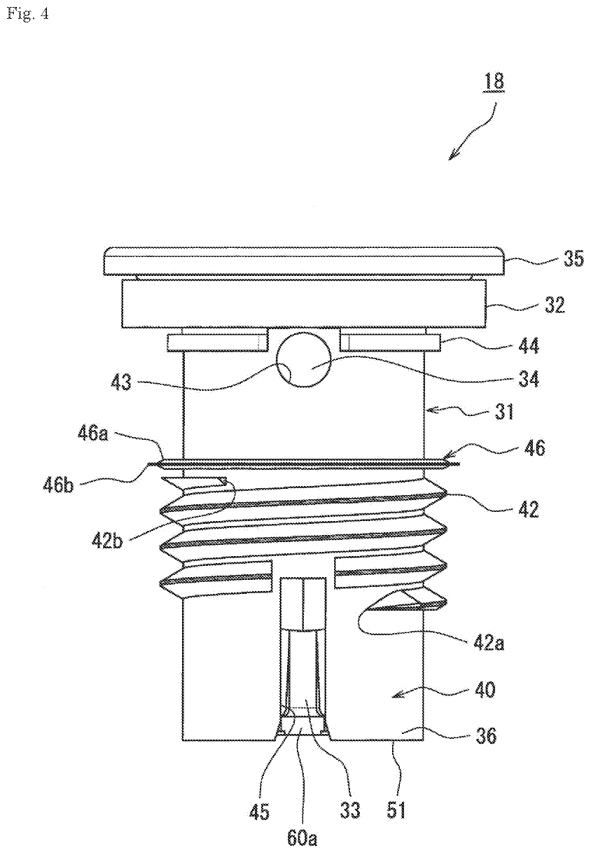

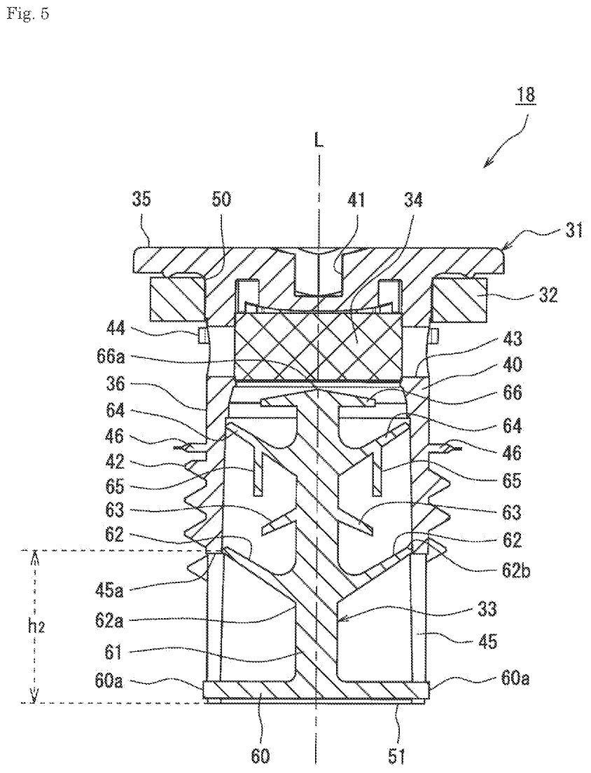

FIG. 2 is a perspective view of the vent plug 18 according to the embodiment of the present invention. Further. FIG. 3 is a front view of the vent plug 18, and FIG. 4 is a rear view of the vent plug 18. Further, FIG. 5 is a cross-sectional view taken along line A-A in FIG. 2, and is a view showing an internal structure of the vent plug 18.

As shown in FIGS. 2 to 5, the vent plug 18 includes a main body portion 31, a packing 32, a splash-proof body 33, and a filter 34.

The main body portion 31 of the vent plug 18 includes a head portion 35 having a circular plate shape, and a cylindrical portion 36 having a substantially cylindrical shape extending from the head portion 35. A tool hole 41 is formed in the head portion 35 of the vent plug 18. Further, a screw thread portion 42 spirally provided with a screw thread is formed on the outer periphery of the cylindrical portion 36. The vent plug 18 is fixed by screwing the screw thread portion 42 to the water filling port 25 provided in the lid 15. In the lead-acid battery 100, a coin, a screwdriver, or the like having a shape corresponding to the tool hole 41 is inserted into the tool hole 41, and the vent plug 18 is rotated, so that the vent plug 18 can be attached and detached.

The cylindrical portion 36 includes a cylinder portion 40, the screw thread portion 42, a restricting portion 44, and a flange portion 46. Here, in the cylindrical portion 36, an end portion on the head portion 35 side is referred to as a first end portion 50, and an end portion on a side opposite to the first end portion 50 is referred to as a second end portion 51. That is, the cylindrical portion 36 is connected to and integrated with the head portion 35 at the first end portion 50. The head portion 35 seals the first end portion 50 of the cylindrical portion 36. The cylinder portion 40 of the cylindrical portion 36 is a cylindrical member having a hollow inside in which an end portion on a side opposite to the head portion 35 is opened. The cylindrical portion 36 holds the filter 34 and the splash-proof body 33 inside the cylinder portion 40. The cylinder portion 40 includes through holes 43 and slits 45. Hereinafter, the central axis of the cylindrical portion 36 is defined as a central axis L, and a direction parallel to the central axis L is referred to as an “axial direction of the cylindrical portion 36”. In the axial direction of the cylindrical portion 36, a direction from the second end portion 51 toward the first end portion 50 is defined as an upward direction, and a direction from the first end portion 50 toward the second end portion 51 is defined as a downward direction.

The restricting portion 44 is a ring-shaped member partially cut out, and protrudes outward from the cylinder portion 40. The packing 32 is a ring-shaped member made of, for example, synthetic rubber. When the vent plug 18 is attached to the water filling port 25, the packing 32 ensures the sealing property between the lid 15 and the vent plug 18. The packing 32 is fitted between the head portion 35 and the restricting portion 44. The packing 32 is provided so as to have an outer diameter smaller than that of the head portion 35 and larger than that of the restricting portion 44, and is held at a predetermined position by the restricting portion 44 and the head portion 35.

The through hole 43 includes an opening portion formed on the inner peripheral surface of the cylindrical portion 36 and an opening portion formed on the outer peripheral surface of the cylindrical portion 36, and is provided so as to connect the opening portion formed on the inner peripheral surface of the cylindrical portion 36 and the opening portion formed on the outer peripheral surface of the cylindrical portion 36. Therefore, the through hole 43 allows the inside and the outside of the cylinder portion 40 (cylindrical portion 36) to communicate with each other. The through hole 43 is provided so as to extend in the radial direction of the cylindrical portion 36. The through holes 43 are connected to the exhaust path (not shown) provided in the lid 15. The gas generated in each cell chamber of the lead-acid battery 100 passes from the inside of the cylinder portion 40 to the exhaust path through the through holes 43, and is discharged from the vent hole 24 to the outside. The through holes 43 are provided at two positions facing each other across the central axis L of the cylindrical portion 36.

The slit 45 is provided to extend from the second end portion 51 of the cylindrical portion 36 toward the first end portion 50. In the example shown in FIGS. 2 to 5, the slits 45 are provided at two positions facing each other across the central axis L of the cylindrical portion 36. The width of the slit 45 is substantially uniform over the entire length in the vertical direction. Since the slits 45 are provided in the vent plug 18, even when the liquid level of the electrolyte solution rises beyond the second end portion which is the lowest portion of the cylindrical portion 36, gas escapes to the through hole 43 and the exhaust path through the slits 45, so that it is possible to suppress the overflow.

As shown in FIGS. 2 to 5, the through hole 43 and the slit 45 are formed at the same position in the circumferential direction of the outer peripheral surface of the cylindrical portion 36. In the slit 45, an end portion on the first end portion 50 side is defined as an end portion 45a. In the present embodiment, the vent plug 18 in which the through hole 43 and the slit 45 are formed at the same position in the circumferential direction of the outer peripheral surface of the cylindrical portion 36 is shown. However, in the vent plug 18, the positional relationship between the through hole 43 and the slit 45 is not limited thereto. That is, the through hole 43 and the slit 45 may be formed at different positions in the circumferential direction of the outer peripheral surface of the cylindrical portion 36.

The screw thread portion 42 is a spiral screw thread provided on the outer peripheral surface of the cylinder portion 40 and protruding outward from the cylinder portion 40. An end portion of the screw thread portion 42 on the second end portion 51 side is defined as a start end portion 42a. Further, an end portion of the screw thread portion 42 on the first end portion 50 side is defined as a terminal end portion 42b. In other words, the start end portion 42a and the terminal end portion 42b are a start end portion and a terminal end of the screw thread portion 42 provided on the outer periphery of the cylinder portion 40 so as to draw a spiral from the second end portion 51 side to the first end portion 50 side.

As shown in FIGS. 2 to 5, in the vent plug 18, the slit 45 and the screw thread portion 42 are provided in an overlapping region of the outer peripheral surface of the cylinder portion 40. That is, in the screw thread portion 42, the screw thread is discontinuously provided.

The flange portion 46 is provided on the outer peripheral surface of the cylindrical portion 36. The flange portion 46 protrudes outward in the circumferential direction of the cylindrical portion 36 from the cylindrical portion 36. In the central axis L direction of the cylindrical portion 36, the cylindrical portion 36 is provided closer to the first end portion 50 than the screw thread portion 42. As shown in FIGS. 2 to 5, the flange portion 46 includes a ring portion 46a and a flange portion 46b.

The ring portion 46a is a ring-shaped member protruding outward in the circumferential direction of the cylindrical portion 36 from the cylindrical portion 36. The ring portion 46a is provided such that the protruding amount from the outer peripheral surface of the cylindrical portion 36 (distance from the outer peripheral surface of the cylindrical portion 36) is substantially the same as the protruding amount of the top portion of the screw thread portion 42. The flange portion 46b is a ring-shaped member protruding further outward in the radial direction of the cylindrical portion 36 from the ring portion 46a. Therefore, the protruding amount of the flange portion 46 from the outer peripheral surface of the cylindrical portion 36 is larger than the protruding amount of the screw thread portion 42.

The filter 34 is a sintered body of ceramics such as alumina or a sintered body of resin particles such as polypropylene, and is a porous body. The filter 34 is an explosion-proof filter, and suppresses intrusion of sparks or the like generated outside into the container 12. As shown in FIGS. 3 to 5, the filter 34 is held inside the cylinder portion 40 of the cylindrical portion 36.

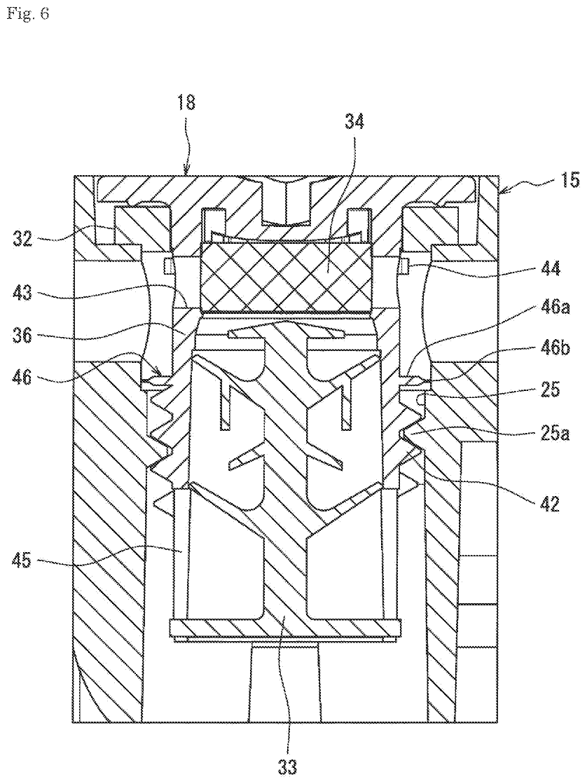

FIG. 6 is a view showing a state in which the vent plug 18 is attached to the water filling port 25 of the lid 15. As shown in FIG. 6, the vent plug 18 is attached to the water filling port 25 of the lid 15 by screwing a screw thread portion 25a provided in the water filling port 25 and a screw thread portion 42a of the vent plug 18. As shown in FIG. 7, the filter 34 is disposed at a position where the through holes 43 are provided in the axial direction of the cylindrical portion 36. The filter 34 is provided so as to close the opening portions of the through holes 43. That is, the filter 34 is provided so as to abut on the opening portions of the cylindrical portion 36 on the inner peripheral surface side in the through holes 43 that allow the inside and the outside of the cylindrical portion 36 to communicate with each other.

As shown in FIG. 5, the splash-proof body 33 is held inside the cylinder portion of the cylindrical portion 36. The splash-proof body 33 is integrally formed of, for example, resin. As shown in FIG. 5, the splash-proof body 33 includes a bottom portion 60, a support column portion 61, first splash-proof plates 62, second splash-proof plates 63, third splash-proof plates 64, fourth splash-proof plates 65, and fifth splash-proof bodies 66. Since the splash-proof body 33 includes the first splash-proof plates 62 to the fifth splash-proof plates 66, an exhaust path of gas has a labyrinthine shape inside the cylindrical portion 36. As a result, the gas generated in the container 12 passes through the inside of the cylindrical body 36 and is discharged to the outside, whereas the electrolyte solution does not easily leak out. Hereinafter, the first splash-proof plates 62 to the fifth splash-proof plates 66 may be collectively referred to as a plurality of splash-proof plates.

The bottom portion 60 is a circular plate-shaped member and is provided to seal the second end portion 51 of the cylindrical portion 36. The diameter of the bottom portion 60 is slightly larger than the inner diameter of the cylindrical portion 36 at the second end portion 51, and the bottom portion 60 of the splash-proof body 33 is press-fitted into the second end portion 51 of the cylindrical portion 36. Thus, the splash-proof body 33 is locked inside the cylindrical portion 36. On the outer peripheral surface of the bottom portion 60, convex parts 60a projecting outward in the circumferential direction are formed at positions corresponding to the slits 45. The convex parts 60a are formed at two positions corresponding to the slits 45, in the vent plug 18, the splash-proof body 33 is press-fitted into the cylindrical portion 36 such that the convex parts 60a are inserted into the slits 45, thereby defining a direction in which the splash-proof body 33 is held in the cylindrical portion 36. The support column portion 61 is a rod-shaped body extending from the center of the bottom portion 60 toward the first end portion side in parallel with the axial direction of the cylindrical portion 36.

The first splash-proof plates 62 are splash-proof plates located closest to the second end portion 51 among the plurality of splash-proof plates included in the splash-proof body 33. A pair of the first splash-proof plates 62 is formed so as to face each other across the central axis L of the cylindrical portion 36. The first splash-proof plate 62 has a substantially semicircular plate shape, and is disposed such that a semicircular straight portion is connected to the support column portion 61 and an arc faces outward. The first splash-proof plate 62 is disposed so as to extend obliquely upward from the support column portion 61.

In the first splash-proof plate 62, a lowermost portion connected to the support column portion 61 is defined as a base portion 62a. In the first splash-proof plate 62, an upper end portion 62b located on the uppermost side (first end portion 50 side) is located above (on the first end portion 50 side of) the end portion 45a of the slit 45. Here, assuming that the distance in the central axis L direction of the cylindrical portion 36 from the second end portion 51 to the upper end portion 62b of the first splash-proof plate 62 is a distance h₂, the distance h₂ satisfies the following relational expression between the distance h₁ representing the depth of the slit 45 and a pitch α (see FIG. 3) of the screw thread portion 42.

h₁<h₂<h₁+α (1)

A case where the distance h₂ is equal to or less than the distance h₁, that is, a case where the depth of the slit 45 is equal to the distance to the upper end portion 62b of the first splash-proof plate 62 or shorter than the distance to the upper end portion 62b of the first splash-proof plate 62 is considered. In such a case, since the end portion 45a of the slit 45 is located closer to the first end portion 50 than the upper end portion of the first splash-proof plate 62, the electrolyte solution easily enters the inside of the cylindrical body 36 from above the first splash-proof body 62 due to vibration or the like. When vibration or the like is further applied to the lead-acid battery 100, the electrolyte solution that has entered the inside of the cylindrical body 36 may flow up in the cylindrical body 36 and overflow.

Considering the case where the distance h₂ is greater than or equal to h₁+α, the distance in the axis L direction from the upper end portion 62b of the first splash-proof plate 62 to the end portion 45a of the slit 45 increases. Therefore, as compared with the case where the distance h₂ is less than h₁+α, the electrolyte solution that has entered the inside of the cylindrical body 36 due to vibration or the like easily hits the inner wall portion of the cylindrical body 36, and the electrolyte solution that has entered the inside of the cylindrical body 36 is less likely to be discharged to the outside of the cylindrical body 36. Also in this case, as in the case described above, when vibration or the like is further applied to the electrolyte solution that has entered the cylindrical body 36, the electrolyte solution may flow up in the cylindrical body 36 and overflow.

As described above, since the vent plug 18 satisfies the above relational expression (1), the vent plug 18 is less likely to cause overflow due to vibration or the like (excellent in dynamic overflow performance).

In the vent plug 18, the upper end portion 62b of the first splash-proof plate 62 is located closer to the first end portion 50 (on the upper side) than the start end portion 42a of the screw thread portion 42.

The second splash-proof plate 63 is provided above the first splash-proof plate 62 (on the first end portion 50 side) and has a substantially rectangular flat plate shape. A pair of the second splash-proof plates 63 is formed so as to face each other across the central axis L of the cylindrical portion 36, and is disposed so as to extend obliquely downward from the support column portion 61.

The third splash-proof plate 64 is provided above the second splash-proof plate 63 and has substantially the same shape as the first splash-proof plate 62. That is, a pair of the third splash-proof plates 64 is formed so as to face each other across the central axis L of the cylindrical portion 36. The third splash-proof plate 64 has a substantially semicircular plate shape, and is disposed such that a chord is connected to the support column portion 61 and an arc faces outward. The third splash-proof plate 64 is disposed so as to extend obliquely upward from the support column portion 61. Also in the third splash-proof plate 64, similarly to the first splash-proof plate 62, a lowermost portion connected to the support column portion61 is referred to as a base portion, and a portion located on the uppermost side (first end portion 50 side) is referred to as an upper end portion.

The fourth splash-proof plate 65 is provided to extend downward from between the base portion and the upper end portion of the third splash-proof plate 64. The fourth splash-proof plate has a substantially rectangular flat plate shape. A pair of the fourth splash-proof plates 65 is formed so as to face each other across the central axis L of the cylindrical portion 36.

The fifth splash-proof plate 66 is provided above the third splash-proof plate 64 and is connected to the top portion of the support column portion 61. An upper end portion 66a of the fifth splash-proof plate 66, which is an end portion on the first end portion 50 side, is an end portion of the splash-proof body 33 on the first end portion 50 side. The upper end portion 66a is located closer to the first end portion 50 than the upper end portion 42b of the screw thread portion 42.

### [Modification Example]

Hereinafter, a modification example of the present invention will be described with reference to the drawings. For convenience of description, members having the same functions as the members described in the embodiment are denoted by the same reference numerals, and description thereof is omitted.

FIG. 7 is a view showing a vent plug 181 according to the modification example, FIG. 7(a) is a plan view of the vent plug 181, and FIG. 7(b) is a rear view of the vent plug 181. As shown in FIG. 7, in the vent plug 181 according to the present modification, a screw thread portion 421 and a flange portion 461 are provided integrally. That is, in the vent plug 18 according to the above-described embodiment, the terminal end portion 42a of the screw thread portion 42 and the flange portion 46 are disposed apart from each other in the central axis L direction of the cylindrical portion 36. On the other hand, in the vent plug 181 according to the present modification example, a terminal end portion 421a of the screw thread portion 421 is connected to the flange portion 461.

As described above, the flange portion 451 only needs to be provided closer to the first end portion 50 than the screw thread portion 421, and the screw thread portion 421 and the flange portion 451 may be provided integrally. Even with such a configuration, the vent plug 181 has the same effect as the vent plug 18 according to the embodiment.

The present invention is not limited to the above-described embodiments, and various modifications can be made within the scope indicated in the claims, and embodiments obtained by appropriately combining technical means disclosed in different embodiments are also included in the technical scope of the present invention.

### [Summary]

(1) A vent plug for a lead-acid battery according to an aspect of the present invention is a vent plug 18 or 181 for a lead-acid battery including a head portion 35, a cylindrical portion 36 extending from the head portion 35, and a filter 34 provided inside the cylindrical portion 36. The cylindrical portion 36 has a through hole 43 that allows an inside and an outside of the cylindrical portion 36 to communicate with each other. The through hole 43 has an opening portion on an inner peripheral surface of the cylindrical portion 36. The filter 34 is provided so as to close the opening portion of the through hole 43.

Here, a case is considered in which part of moisture in the electrolyte solution held in the container 12 is evaporated, and water vapor generated by the evaporation is released to the outside of the lead-acid battery 100 through the through hole 43 of the vent plug. In the vent plug 18 or 181 according to an aspect of the present invention, the opening portion of the through hole 43 on the inner peripheral surface side which is provided in the cylindrical portion 36 of the vent plug 18 or 181 is closed by the filter 34. Therefore, as compared with the case where the filter 34 does not close the through hole 43, the gas containing water vapor is less likely to be released from the through hole 43 to the outside of the vent plug 18 or 181. That is, the ventilation resistance of the gas flowing from the inside of the cylindrical portion 36 to the exhaust path through the through hole 43 increases as compared with the case where the filter 34 does not close the through hole 43, and as a result, it is possible to suppress the liquid depletion.

(2) In the vent plug for a lead-acid battery (vent, plug 18, vent plug 181) according to an aspect of the present invention, the cylindrical portion 36 may include a screw thread portion 42 or 421 provided on an outer peripheral surface, and the cylindrical portion 36 may include a flange portion 46 or 461 protruding outward in a radial direction of the cylindrical portion 36 than the screw thread portion 42 or 421.

Since the opening portion of the through hole 43 on the inner peripheral surface side is closed by the filter 34, it is conceivable that the gas containing water vapor is discharged to the outside of the lead-acid battery 100 through between the screw thread portion 42 or 421 of the vent plug 18 or 181 and the screw thread portion 25a of the water filling port 25 without passing through the inside of the vent plug 18 or 181. According to the above configuration, since the flange portion 46 or 461 protruding outward in the radial direction of the cylindrical portion 36 than the screw thread portion 42 or 421 is provided, it is possible to suppress the gas containing water vapor from being discharged to the outside of the lead-acid battery 100 through between the screw thread portion 42 or 421 of the vent plug 18 or 181 and the screw thread portion 25a of the water filling port 25. That is, by providing the flange portion 46 or 461, it is possible to seal between the outer peripheral surface of the cylindrical portion 36 and the water filling port 25. Therefore, it is possible to provide a vent plug for a lead-acid battery capable of further suppressing the liquid depletion.

(3) In the vent plug for a lead-acid battery (vent plug 181) according to an aspect of the present invention, the flange portion 461 may be provided integrally with the screw thread portion 421.

(4) In the vent plug for a lead-acid battery (vent plug 18, vent plug 181) according to an aspect of the present invention, a plurality of the through holes 43 may be provided at positions facing each other.

(5) A lead-acid battery 100 according to an aspect of the present invention may include the vent plug 18 or 181 described above.

### DESCRIPTION OF REFERENCE SIGNS

18: vent plug (vent plug for lead-acid battery)

34: filter

36: cylindrical portion

42: screw thread portion

43: through hole

100: lead-acid battery

181: vent plug

421: screw thread portion

461: flange portion

1. A vent plug for a lead-acid battery comprising:
a head portion;
a cylindrical portion extending from the head portion; and
a filter provided inside the cylindrical portion,
wherein the cylindrical portion has a through hole that allows an inside and an outside of the cylindrical portion to communicate with each other,
wherein the through hole has an opening portion on an inner peripheral surface of the cylindrical portion, and
wherein the filter is provided so as to close the opening portion of the through hole.

2. The vent plug for a lead-acid battery according to claim 1,
wherein the cylindrical portion includes a screw thread portion provided on an outer peripheral surface, and
wherein the cylindrical portion includes a flange portion protruding outward in a radial direction of the cylindrical portion than the screw thread portion.

3. The vent plug for a lead-acid battery according to claim 2, wherein the flange portion is provided integrally with the screw thread portion.

4. The vent plug for a lead-acid battery according to claim 1, wherein a plurality of the through holes are provided at positions facing each other.

5. A lead-acid battery comprising the vent plug for a lead-acid battery according to claim 1.
